(19) United States
(12) Patent Application Publication
(10) Pub. No.: US 2025/0170842 A1
(43) Pub. Date: May 29, 2025

(54) PRINTING SYSTEM WITH A FIRST AND SECOND RECEIVING MEANS

(71) Applicant: Durst Group AG, Brixen (IT)

(72) Inventors: Eduard BRUNNER, Klausen (IT); Manuel PROSCH, Brixen (IT)

(21) Appl. No.: 18/844,289

(22) PCT Filed: Mar. 21, 2023
(86) PCT No.: PCT/EP2023/025124

§ 371 Date: Sep. 5, 2024

(30) Foreign Application Priority Data
May 27, 2022 (IT) 102022000011144

(51) Int. Cl. B41J 15/04; B41J 2/17; B41J 3/407; B41J 11/00; B41J 29/02

(52) U.S. Cl. CPC B41J 15/046; B41J 2/1721; B41J 3/4078; B41J 11/0085; B41J 15/048; B41J 29/02

(57) ABSTRACT

Please amend the ABSTRACT as follows:

Printing system with a base body and a printing unit for printing a material web by ejecting ink droplets, wherein the printing unit is positioned at a distance relative to the base body. The system includes a first and a second holding means. When in the printing position, either the first or the second holding means allows the positioning of the material web within the effective area of the printing unit. The base body includes a support frame to which means are mounted for moving the material web in the transport direction into and out of the effective area of the printing unit. The base body is designed such that the first holding means can be moved between a printing position within the effective area of the printing unit, where it is blockable against movement by first and third locking means, and a first rest position within the base body. Similarly, the second holding means can be moved between a printing position within the effective area of the printing unit, where it is blockable against movement by second and fourth locking means, and a second rest position within the base body. During the printing of the material web with the printing unit, either the first or the second holding means is moved to the printing position and locked against movement by the respective locking means

The present invention relates to a printing system with a first and second receiving means according to the preamble of claim 1.

In the prior art, a known inkjet printing device with a means for absorbing ink is disclosed in WO02/22362A2. Specifically, it reveals an inkjet printing device for roll and sheet media, flexible and rigid, as well as impermeable and porous media, comprising (a) a liftable and lowerable printhead assembly with at least one printhead for printing the medium, (b) a liftable and lowerable printing table over which the medium to be printed is guided at the time of printing, (c) an ink catching device that can be used in the area of the printing table, consisting of an ink absorption pad and two supporting edges arranged laterally thereto, and (d) several separately controllable rollers that can be used as transport and/or feed and/or braking rollers and transport the medium to be printed and/or advance it by a defined feed length and/or brake it to apply tensile tension to it.

In the new condition of the ink absorption pad, it is possible to avoid dirt formation by ink droplets on the printing table lying under the porous medium because the ink droplets passing through the porous medium during printing are absorbed and stored in the ink absorption pad. However, once the pad is saturated with ink, it loses its dirt-preventing effect, so that further ink droplets passing through the porous medium hit the non-absorbed ink and bounce back. This creates an ink droplet mist that contaminates the medium to be printed, the printing table, and the printhead assembly. Furthermore, ink absorption pads have a very limited ink absorption capacity, so they need to be replaced regularly and at relatively short intervals. However, such pads are very expensive.

In an alternative embodiment of the above-described inkjet printing device known from the prior art, the ink catching device used in the area of the printing table comprises an ink insert pad that does not absorb ink instead of the ink absorption pad. Thus, if the same amount of ink as with the ink absorption pad is to be received with the ink insert pad, the distance between the material web and the side of the ink insert pad facing it must be greater than with the ink absorption pad. This is simply because the ink passing through the material web is stored on the pad instead of in the pad. Such ink insert pads are suitable, for example, when curable ink, especially UV-curable ink, is used, as it can be stacked into a pile of cured layers and stored in this form when the ink applied to the medium is cured with UV radiation, thereby also curing the ink that has reached the insert pad.

However, such an ink pad has the disadvantage that due to its non-absorbency, increased mist formation occurs. To be able to absorb a large amount of ink, a new ink pad must be placed at a relatively large distance, typically greater than 5 mm to about 15 mm, below the material web. The larger the corresponding distance, the greater the amount of cured ink that can be stacked and thus stored. Naturally, with increasing distance, mist formation also increases. If a technician fails to replace an older ink pad in time, the underside of the mesh-like material web comes into direct contact with the piled-up cured ink layers and gets contaminated as a result. Accordingly, the ink absorption capacity of such pads is also very limited.

From the document, DE202019100635U1 which is seen as prior art, an inkjet printer with an ink collection device is described, which allows for an increased service life of the ink collection device. In particular, this prior art document discloses an inkjet printer with a removably inserted ink collection device, comprising: (A) a printing table with a support surface for receiving a material web and a printing module spaced apart from the printing table with at least one row of nozzles for printing the material web with ink droplets, whereby the printing module defines a printing action area; (B) a guiding unit that provides a mesh-like material web and includes first means for guiding it into the printing action area between the printing table and the printing module and subsequently storing it; whereby the ink collection device for collecting ink droplets that pass through the mesh-like material web during printing is removably inserted in the printing action area between the printing table and the mesh-like material web.

The ink collection device disclosed in DE202019100635U1 has a endless conveyor belt and a cleaning unit for removing the collected ink droplets from the conveyor belt, whereby the conveyor belt is designed with two deflection rollers, an upper run for collecting the ink, and a lower run, and the ink collection device comprises two support edges arranged so that the mesh-like material web is guided at a distance greater than zero from the upper run, and the ink collection device includes a motor, and the inkjet printer is designed so that at least one of the deflection rollers is driven by the motor at least intermittently, preferably all the time, during printing.

The disadvantages here are the long retooling times required for installing the ink collection device in the inkjet printer in the area of the printing table and subsequently for removing it from the inkjet printer, as efficiency in installing and removing the ink collection device can only be achieved with expertise implemented by trained and experienced personnel. Additionally, there should be sufficient space next to the inkjet printer for storing the removed ink collection device until its next use, so that the personnel can save travel time to and from the storage location. The ink collection device and the printing table are each an example of a holding means for positioning a material web.

It would therefore be desirable to have a printing system that enables a reduction in setup time when retrofitting the same from a first holding means in the printing position to a second holding means in the printing position and vice versa.

The present invention is thus based on the general object of providing a printing system that enables a reduction in setup time when retrofitting the same from a first holding means in the printing position to a second holding means in the printing position and vice versa.

According to the invention, this object is achieved with a printing system that includes the features of claim 1. The respective dependent claims refer to further advantageous and, if applicable, additional inventive embodiments.

The printing system according to the present invention is a printing system with a base body and a printing unit for printing a material web by ejecting ink droplets, which printing unit is arranged at a distance from the base body, as well as a first and a second holding means, whereby the first and/or second holding means, when placed in the printing position, allows positioning of the material web in the action area of the printing unit, whereby the base body comprises a support frame, on which means are mounted for moving the material web into the action area of the printing unit and out of the action area again.

According to the invention, the base body is designed such that the first holding means can be moved between a printing position in the action area of the printing unit, in which position the first holding means can be blocked against movement by first and third locking means, and a first rest position within the base body, and such that the second holding means can be moved between a printing position in the action area of the printing unit, in which position the second holding means can be blocked against movement by second and fourth locking means, and a second rest position within the base body, whereby during the printing of the material web with the printing unit, the first or the second holding means is moved into the printing position and blocked against movement by the corresponding locking means.

According to a preferred embodiment, the first receiving means in the printing position can be locked against movement by first locking means attached to the support frame, which are designed to engage with third locking means attached to the first receiving means and the second receiving means in the printing position can be locked against movement by second locking means attached to the support frame, which are designed to engage with fourth locking means attached to the second receiving means.

Preferably, the first and third locking means are designed as corresponding locking elements. The second and fourth locking means are also preferably designed as corresponding locking elements. In this context, one set of locking elements can be designed, for example, as a groove, recess, or opening, into which the other corresponding locking elements, preferably designed as a pin or bolt, engage. Particularly preferred is a locking means designed for releasable form-fitting engagement with the other locking means.

Through the respective locking means, the first or second receiving means can be securely held in the desired printing position.

According to a preferred embodiment, the base body comprises two parallel sliding rails that carry the second receiving means at its opposite ends and which extend outside the effective range of the printing unit at an angle in the range of 10 degrees to 35 degrees, preferably in the range of 12 degrees to 24 degrees, and particularly preferably in the range of 15 degrees to 21 degrees downwards and in or against the transport direction of the material web in such a way that this allows the second receiving means, provided with guiding elements, to be manually or automatically moved along the sliding rails from its printing position to the second resting position by suitable first adjusting means and whereby the second receiving means can also be moved substantially vertically, preferably in the vertical direction, between its printing position and the lowered first resting position relative to its printing position with the help of a pneumatic or motorized lifting system.

The combination of the sliding rails and the lifting system offers the advantage that the printing system can be realized in a compact, simple, and cost-effective manner, and the second receiving means can be adjusted between both positions with great ease.

When a one-degree angle is mentioned in this description, it is understood as the 360th part of a full angle of 360°. When vertical direction is mentioned, it is understood as the direction of gravity, with “substantially vertical direction” meaning that a corresponding direction allows for an inclination angle of at most 10 degrees, particularly at most 5 degrees, from the vertical direction. A fictitious horizontal plane is understood as a plane aligned perpendicular to the direction of gravity.

In a highly preferred embodiment, the sliding rails extend horizontally in or against the transport direction of the material web at least within the effective range of the printing unit. This development offers the advantage that moving the second receiving means, particularly from the second resting position to its printing position, becomes even easier.

The two parallel sliding rails can each be part of the support frame or each be mounted on the support frame.

The pneumatic lifting system can typically have at least two or at least four synchronously extendable and retractable pneumatic cylinders.

The guiding elements can include wheels mounted on the second receiving means.

According to a preferred embodiment, the first receiving means is an ink collection device, and the second receiving means is a suction table that can be subjected to negative pressure. According to an alternative preferred embodiment, the first receiving means is a suction table that can be subjected to negative pressure, and the second receiving means is an ink collection device. These developments have the advantage that the printing system can be used without difficulty for both mesh-like material webs and impermeable material webs.

Both the first and second receiving means can be of elongated design, with their longitudinal axis preferably oriented transversely to the transport direction of the material web. The length of each receiving means along the longitudinal axis can be between 1.5 meters and 5 meters, preferably between 3 meters and 5 meters.

An impermeable material web is understood as a material web impermeable to ink drops, where ink drops impacting the material web during printing do not pass through it, unlike with a mesh-like material web. A mesh-like material web can, for example, be a mesh material web.

According to another preferred embodiment, the ink collection device comprises an endless conveyor belt running between two deflection rollers, for collecting and transporting away ink drops passing through a mesh-like material web during printing and it also includes two guide edges arranged transversely to the transport direction of the material web on opposite sides of the conveyor belt so that the mesh-like material web can be guided over the conveyor belt at a distance greater than zero when the mesh-like material web is under tension in the transport direction whereby the conveyor belt can be driven by at least one of the two deflection rollers, which is connected to a motor.

In a preferred embodiment of the printing system, the two guide edges are arranged so that the mesh-like material web is guided over the directly viewing side of the conveyor belt at a distance of 1 mm to 5 mm, preferably 1 mm to 4 mm, and most preferably 2 mm to 3 mm. This can keep the formation of ink mist at a constantly low and acceptable level.

The ink collection device can include a cleaning unit for removing ink from the conveyor belt. According to a particularly preferred embodiment, the cleaning unit comprises a blade with a cutting edge, arranged at one of the deflection rollers so that when the conveyor belt runs over at least one deflection roller, and ink drops hardened or dried on the conveyor belt can be scraped off by the cutting edge.

The printing system can be designed to move the printing unit bidirectionally along a scan axis, oriented transversely to the transport direction of the material web, over the first or second receiving means to print the material web with ink drops in one or both corresponding directions along the scan axis, defining the effective range of the printing unit.

The base body can include at least one plate facing the printing unit in the entry and/or exit area, which at least partially encloses the effective range of the printing unit and forms the upper side of the base body.

According to a highly preferred embodiment, the plate in the entry or exit area has a flap that can be opened away from the effective range of the printing unit, movable between a closed position and an opened position, so that in the opened position, access to the second resting position under the flap is provided to the second receiving means, and in the closed position, access to the second resting position is blocked for the second receiving means by the flap. This development has the advantage of increasing the reliability of the correct positioning of the material web around the effective range of the printing unit and partially protecting the interior of the base body from the ingress of contaminating particles from the ambient air.

The entry area is the area where the plate is arranged, and through which the material web enters the effective range of the printing unit. Correspondingly, the exit area is the area where the plate is arranged, and through which the material web exits the effective range of the printing unit.

Typically, the guide edges of the ink collection device or the surface of the suction table, when the ink collection device or suction table is in the printing position, are arranged higher than the surface of the plate facing the printing unit, preferably by two millimeters to ten millimeters, particularly preferably by two millimeters to five millimeters, and most preferably by two millimeters to three millimeters higher than the surface of the plate facing the printing unit. This makes it possible to reduce any friction between the underside of the material web, lying opposite the printed front side of the material web, and the plate, thereby reducing the risk of smearing an image printed on the underside in the case of two-sided printing.

Alternatively, the respective guide edges or the surface of the suction table can be arranged in flush with the surface of the plate.

Means for moving the material web in the transport direction into and out of the effective range of the printing unit can include several separately controllable rollers that can be used as transport and/or feed, and/or braking rollers to transport the material web and/or move it forward by a defined feed length in the transport direction and/or brake it to apply tension.

In a preferred embodiment, the printing system comprises a collection container associated with the cleaning unit for collecting the ink removed by the cleaning unit.

According to a particularly preferred embodiment, the printing system is a drop-on-demand inkjet printing system.

In a particularly preferred embodiment, the printing system comprises second adjustment means designed to move the printing unit in a direction perpendicular to the material web positioned within the effective range of the printing unit, i.e., in the direction of gravity, to adjust the height between the printing unit and the material web within the effective range of the printing unit.

1. A printing system with a base body and a printing unit for printing a material web by ejecting ink drops, which printing unit is arranged spaced relative to the base body, as well as a first and a second holding means, wherein the first or second holding means, when brought into the printing position, allows positioning of the material web within the effective range of the printing unit, wherein the base body comprises a support frame, on which means are mounted for transporting the material web into and out of the effective range of the printing unit, wherein the base body is configured such that the first holding means can be moved between a printing position within the effective range of the printing unit, in which the first holding means can be blocked against movement by first and third locking means, and a first rest position within the base body, and that the second holding means can be moved between a printing position within the effective range of the printing unit, in which the second holding means can be blocked against movement by second and fourth locking means, and a second rest position within the base body, wherein during printing of the material web with the printing unit, the first or the second holding means is brought into the printing position and blocked against movement by the corresponding locking means.

2. The printing system according to claim 1, wherein the first holding means in the printing position can be blocked against movement by first locking means attached to the support frame, which are designed to engage third locking means attached to the first holding means, and that the second holding means in the printing position can be blocked against movement by second locking means attached to the support frame, which are designed to engage fourth locking means attached to the second holding means.

3. The printing system according to claim 1, wherein the base body comprises two parallel guide rails that carry the second holding means at its opposite ends, and that extend at least partially outside the effective range of the printing unit under an angle in the range of 10 degrees to 35 degrees downwards and in or against the transport direction of the material web, such that the second holding means provided with guide elements can be moved manually or automatically along the guide rails from its printing position to the second rest position by suitable first adjustment means, and wherein the second holding means can be moved at least substantially in the vertical direction, between its printing position and the first rest position lowered relative to its printing position by means of a pneumatic or motorized lifting system.

4. The printing system according to claim 3, wherein the guide rails extend horizontally in or against the transport direction of the material web at least in the effective range of the printing unit.

5. The printing system according to claim 3, wherein the guide elements comprise wheels mounted on the second holding means.

6. The printing system according to claim 1, wherein the first holding means is an ink catching device and the second holding means is a suction table, or that the first holding means is a suction table and the second holding means is an ink catching device.

7. The printing system according to claim 6, wherein the ink catching device comprises an endless conveyor belt running between two deflection rollers for catching and removing ink drops passing through a mesh-like material web during printing, as well as two guide edges arranged transversely to the transport direction of the material web and on opposite sides of the conveyor belt, such that the mesh-like material web can be guided in the transport direction of the material web at a distance greater than zero from the section of the conveyor belt facing the mesh-like material web when the mesh-like material web is under tension in the transport direction, wherein the conveyor belt can be driven at least by one of the two deflection rollers, which is connected to a motor.

8. The printing system according to claim 7, wherein the ink catching device comprises a cleaning unit for removing ink from the conveyor belt.

9. The printing system according to claim 8, wherein that the cleaning unit comprises a blade with a cutting edge, wherein the cleaning unit is arranged at one of the deflection rollers such that when the conveyor belt runs over at least one deflection roller and ink drops collected on the conveyor belt harden or dry, the cutting edge can scrape off hardened or dried ink drops from the conveyor belt.

10. The printing system according to claim 3, wherein the base body comprises at least one plate facing the printing unit in the inlet and/or outlet area of the printing unit, which at least partially encloses the effective range of the printing unit and forms an upper side of the base body, wherein the plate comprises a flap in the inlet or outlet area that can be opened away from the effective range of the printing unit, which can be moved between a closed position and an opened position, such that in the opened position access to the second rest position under the flap is provided to the second holding means, and in the closed position access to the second rest position is blocked by the flap.

11. The printing system according to claim 7, wherein the mesh-like material web is a mesh material web.

12. The printing system according to claim 1, wherein the guide edges of the ink catching device or the surface of the suction table subjected to negative pressure, when the ink catching device or the suction table is brought into the printing position, are arranged higher than the surface of the plate facing the printing unit.
